(19) United States
(12) Patent Application Publication
(10) Pub. No.: US 2026/0057250 A1
(43) Pub. Date: Feb. 26, 2026

(54) LATENT EWALD SUMMATION FOR MACHINE LEARNING OF LONG-RANGE INTERACTIONS OF ATOMISTIC SYSTEMS

(71) Applicant: THE REGENTS OF THE UNIVERSITY OF CALIFORNIA, Oakland, CA (US)

(72) Inventor: Bingqing Cheng, Berkeley, CA (US)

(21) Appl. No.: 19/307,702

(22) Filed: Aug. 22, 2025

Related U.S. Application Data
(60) Provisional application No. 63/687,048, filed on Aug. 26, 2024.

(51) Int. Cl. G06N 3/10

(52) U.S. Cl. CPC G06N 3/10

(57) ABSTRACT

A computing device usable in an atomistic system, comprising: one or more processors configured to execute code: compute descriptors of atomic environments of all atoms in the atomistic system, determine a short-range energy for each atom, define a long-range neural network to map invariant features of each atom to one or more hidden variables, perform an Ewald summation on the hidden variables to determine a long-range energy of the system, and sum the short-range energy and the long-range energy to determine total energy of the system. A computer-implemented method of augmenting an existing machine learning interatomic potential systems (MLIP) in an atomistic system, defining a long-range neural network to map invariant features of each atom to a hidden variable, and performing an Ewald summation on the hidden variables to determine a long-range energy of the system.

### CROSS-REFERENCE TO RELATED APPLICATIONS

This disclosure is a non-provisional of and claims benefit from U.S. Provisional Application No. 63/687,048, titled “LATENT EWALD SUMMATION FOR MACHINE LEARNING OF LONG-RANGE INTERACTIONS,” filed on Aug. 26, 2024, the disclosure of which is incorporated herein by reference in its entirety.

### TECHNICAL FIELD

This disclosure relates to machine learning interatomic potentials (MLIP), more particularly to MLIPs including long-range interactions.

### BACKGROUND

Machine learning interatomic potentials (MLIPs) can learn from reference quantum mechanical calculations and then predict the energy and forces of atomic configurations quickly, thus allowing for a more accurate and comprehensive exploration of material and molecular properties at scale. Most state-of-the-art MLIP methods use a short-range approximation: the effective potential energy surface experienced by one atom is determined by its atomic neighborhood. This approximation implies that the total energy is the sum of atomic contributions, which also makes the short-range MLIPs scale linearly with system size.

The short-range MLIPs, however, neglect all kinds of long-range interactions such as Coulomb and dispersion. Although short-range potentials may be sufficient for describing most properties of homogeneous bulk systems, they may fail for liquid-vapor interfaces, dielectric response, dilute ionic solutions with Debye-Hückel screening, and interactions between gas phase molecules.

There has been a continuous effort to incorporate long-range interactions into MLIPs. One can include empirical electrostatics and dispersion baseline corrections, but for many systems, such baseline is not readily available. Another option is to predict effective partial charges to each atom, which are then used to calculate long-range electrostatics. For example, the fourth-generation high-dimensional neural network potential (4G-HDNNPs) predicts the electronegativities of each nucleus and then uses a charge equilibration scheme to assign the charges. 4G-HDNNPs are trained directly to reproduce atomic partial charges from reference quantum mechanical calculations, although partial charges are not physically observable, and their values depend on the specific partitioning scheme used. In a similar vein, the deep potential long range (DPLR) learns maximally localized Wannier function centers (MLWFCs) for insulating systems, and the self-consistent field neural network (SCFNN) predicts the electronic response via the position of the ML-WFCs. Message passing neural networks (MPNNs) employ a number of graph convolution layers to communicate information between atoms, thereby capturing long-range interaction up to the local cutoff radius times the number of layers. However, if parts of the system are disconnected on the graph, e.g., two molecules with a distance beyond the cutoff, the message passing scheme does not help. An interesting approach is the long-distance equivariant (LODE) method, which uses local descriptors to encode the Coulomb and other asymptotic decaying potentials (1/r^{p}) around the atoms.

### BRIEF DESCRIPTION OF THE DRAWINGS

FIG. 1 shows graphs of comparisons of short-range (SR) and long-range (LR) machine learning interatomic potential performance for three dimer classes.

FIG. 2 shows learning curves of energy and force mean absolute errors on a bulk water dataset.

FIG. 3 shows a graph of predicted dipole density correlations in reciprocal space.

FIG. 4 shows learning curves on the liquid-vapor water interface data set.

FIG. 5 shows a comparison of interface properties of water predicted using short-range and long-range models.

FIG. 6 shows a flowchart of an embodiment of a method of using machine learning to determine long-range interactions of atomistic systems.

FIG. 7 shows a comparison of the electrical response of the RPDE-D3 (Revised Perdew-Burke-Ernzerhof density functional with Grimme's D3 dispersion coefficients) bulk water between density function theory (DFT) and Latent Ewald Summation (LES).

FIG. 8 shows a comparison between an IR spectrum of water and the LES model trained on energy and forces with a radius cutoff of 4.5.

FIG. 9 shows comparisons of the electrical response between DFT and LES for an ionic liquid, superionic water, and ice.

FIG. 10A and FIG. 10B show graphs of molecular dimer detection between DFT and MLP with and without external electrical fields.

FIG. 11 shows a graphic representation of the integration of LES with any short-ranged machine learning interatomic potentials (MLIP).

FIG. 12A and FIG. 12B show benchmark short-ranged and LES-augmented MLIPs for bulk water.

FIGS. 13A-13C show benchmarks for short-ranged and LES-augmented MLIP for dipeptides.

FIG. 14 shows a comparison of root square errors for energy and forces between MACE-OFF 23 (Multi-layer Atomic Cluster Expansion for Transferable Organic Force Fields) with and without LES augmentation.

FIG. 15 shows a comparison of infrared absorption spectra of bulk liquid between MACE-OFF models and MACE-OFF with LES augmentation.

FIG. 16A and FIG. 16B show graphs of predicted densities and heats of vaporization for multiple molecular liquids under ambient conditions using MACELES-OFF.

FIG. 17 shows a comparison of root mean square deviation of a protein across models.

### DETAILED DESCRIPTION OF THE EMBODIMENTS

The embodiments herein involve a simple method, referred to in this discussion as the Latent Ewald Summation (LES), for accounting for long-range interactions of atomistic systems. The method of the embodiments can be incorporated into most existing MLIP architectures, including potentials based on local atomic environments, such as HDNNP, Gaussian Approximation Potentials (GAP), Moment Tensor Potentials (MTPs), atomic cluster expansion (ACE) and MPNN (e.g., NequIP, MACE, many body atomic cluster expansion). The embodiments herein combine LES with Cartesian atomic cluster expansion (CACE) MLIP. The discussion below also provides benchmarks for LES on selected molecular and material systems.

For a periodic atomic system, the total potential energy is decomposed into a short-range and a long-range part, E=E^{sr}+E^{lr}. As is standard in most MLIPs, the short-range energy is summed over the atomic contribution of each atom i.

$${E}^{ST} = {\sum }_{i} {E}_{θ} ( {B}_{i} ) , \qquad ( 1 )$$

where E_{θ} is a multilayer perceptron with parameters θ that maps the invariant features (B) of an atom to its short-range atomic energy. B can be any invariant features used in different MLIP methods, including those based on local atomic environment descriptors such as ACE, atom centered symmetry functions, smooth overlap of atomic positions (SOAP), or any latent invariant features in MPNNs.

For the long-range part, another multilayer perceptron with parameters ϕ maps the invariant features of each atom i to a hidden variable, i.e.

$${q}_{i} = {Q}_{ϕ} ( {B}_{i} ) . \qquad ( 2 )$$

The structure factor S(k) of the hidden variable is defined as

$$S ( k ) = {\sum }_{i} {q}_{i} {e}^{i k {r}_{i ,}} \qquad ( 3 )$$

where k=(2πnₓ/Lₓ, 2πn_{y}/L_{y}, 2πn_{z}/L_{z}) is a reciprocal vector of the orthorhombic cell, and rᵢ is the Cartesian coordinates of atom i. The long-range energy is then obtained using the Ewald summation:

$${E}^{lr} = \frac{1}{V} {\sum }_{0 < k < {k}_{c}} \frac{{e}^{- {σ}^{2} {k}^{2} / 2}}{{k}^{2}} {\vert S ( k ) \vert}^{2} , \qquad ( 4 )$$

where σ is a smearing factor which would typically be set to 1 Å, k=|k| is the magnitude, and k_{c} is the maximum cut-off.

The LES method can be interpreted in two ways. First, the hidden variable q is analogous to environment-dependent partial charges on each atom. This implies that the method is at least as expressive as those explicitly based on learning partial atomic charges, as it would yield the same results if q replicated the partial charges. Additionally, q can be multi-dimensional or even vectors or high-order tensors, potentially enhancing expressiveness further. Unlike partial charges, q is not constrained by requirements such as charge neutrality or correct charge magnitudes. Since the Ewald summation of q does not need to correspond to a physical electrostatic potential, Eqn. (4) omits the self-interaction term present in the regular Ewald summation for long-range charge interactions. The second interpretation of LES is as a mechanism that allows atoms far apart in the simulation box to communicate their local information. In this sense, LES is related to the recent Ewald-based long-range message-passing method, which facilitates message exchange between atoms in reciprocal space.

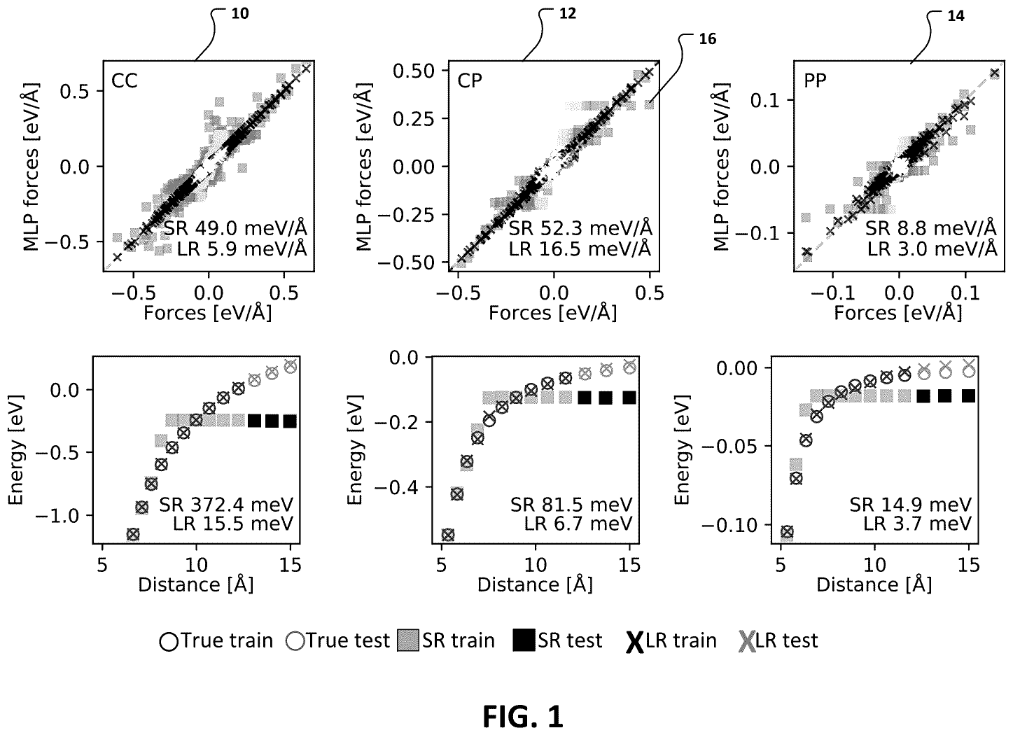

In an experiment, the inventors benchmarked the LES method on the binding curves between dimers of charged (C), polar (P), and apolar (A) relaxed molecules at various separations in a peri-odic cubic box with a 30 Å edge length. The dataset includes energy and force information calculated using the HSE06 hybrid density functional theory (DFT) with a many-body dispersion correction. One example from each of the three dimer classes, CC, CP, and PP, was selected, derived from the combination of the three monomer categories. FIG. 1 shows a snapshot of each example as 10, 12, 14, respectively.

The goal of this benchmark is to evaluate whether the MLIP models can extrapolate dimer interactions at larger separations based on training data from smaller distances. For each molecular pair, the training set consists of 10 configurations with dimer separation distances between approximately 5 Å and 12 Å, and the testing set includes 3 configurations with separations between about 12 Å and 15 Å.

For each molecular pair, the inventors trained a short-range (SR) model using CACE with a cutoff r_{cut}=5 Å, 6 Bessel radial functions, c=8, lₘₐₓ=2, vₘₐₓ=2, N_{embedding}=3, and one message passing layer (T=1). It is worth noting that this “SR” model setting already achieves a perceptive field of 10 Å via the message passing layer, which is quite typical for current MPNNs. In comparison, more traditional MLIPs based on local atomic descriptors typically use a cutoff of around 5 or 6 Å, making them even more short-ranged.

In the long-range (LR) model, the short-range component E^{sr} used the same CACE setup, while the long-range component E^{lr} employed a 4-dimensional hidden variable computed from the same CACE B-features and utilized Ewald summation (Eqn. (4)) with σ=1 Å and a k-point cutoff of kc=2π/3. It is important to fit both energy and forces for these datasets, as fitting only to a few energy values may result in models that accurately predict binding energy but perform poorly on forces.

FIGS. 1A-1C demonstrate that the LR MLIPs outperform the SR MLIPs across all cases. Furthermore, SR models fail to adequately capture the training data, as indicated by the flattening of the binding curves and the large discrepancies between some predicted and true forces, shown by the symbols such as 16. The primary limitation of the SR models is that molecules separated by distances beyond the MLIP cutoff exist on independent atomic graphs, rendering the message passing layers ineffective for communication between the dimers. The improvement achieved by the LR models for the CA, PA, and AA cases is more modest, though the energy scales=in these systems are much smaller, and the absolute RMSE values are relatively low. The residual RMSEs can also be attributed to the limited (only 10) training data points used in each case. Direct comparison of the accuracy of the present LR models with the LODE method is challenging, as different training protocols were employed, and LODE depends significantly on the choice of the potential exponent p for each dimer class. However, based solely on RMSE values, the LR models presented here appear to be more accurate. For example, in the CC class, the energy RMSE is 15.5 meV, compared to approximately 0.1 eV for LODE with the optimal choice of p.

As an example application to dipolar fluids, the inventors applied the LES method to a dataset of 1,593 liquid water configurations, each containing 64 molecules. The dataset was computed using revPBE0-D3 DFT. For the CACE representation, the inventors employed a cutoff of r_{cut}=5.5 Å, 6 Bessel radial functions with c=12, lₘₐₓ=3, vₘₐₓ=3, N_{embedding}=3, and either no message passing (T=0) or one message passing layer (T=1). For the long-range component, the inventors used a 4-dimensional q, a maximum cut-off of k_{c}=π, and σ=1 Å in the Ewald summation.

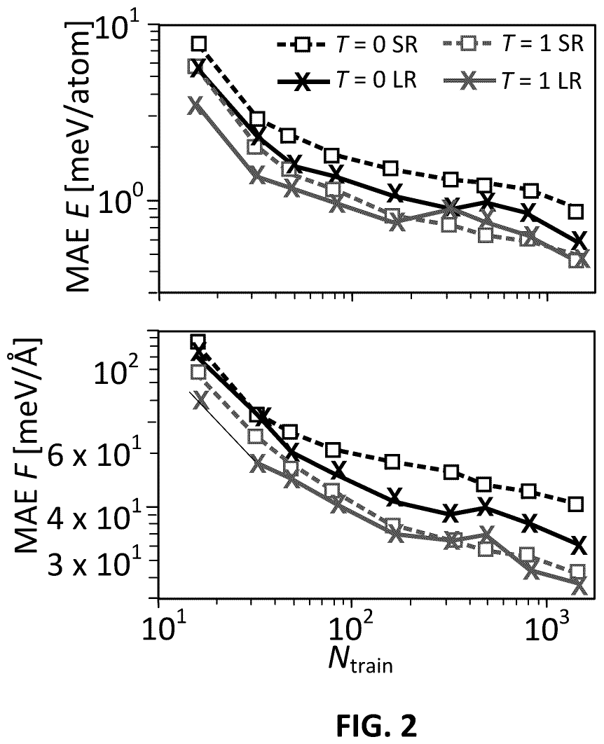

FIG. 2 shows learning curves of energy (E) and force (F) mean absolute errors (MAEs) on the bulk water dataset, using short-range (SR) or long-range (LR) models and with or without massage passing layers (T=0 or T=1).

The learning curves in FIG. 2 demonstrate that message passing significantly improves the accuracy of the MLIPs, consistent with previous studies. The LR component further reduces the error for both models without a message passing layer (T=0) and with one message passing layer (T=1). The improvement is particularly notable in the T=0 scenario. For the T=1 models, the LR component results in a smaller reduction in errors, likely because the T=1 SR models already capture atomic interactions up to 11 Å. Nevertheless, the T=1 LR model demonstrates greater efficiency in learning with less data. The inventors also compared the inference speeds of these models during molecular dynamics (MD) simulations, as detailed below.

The inventors then investigated the effect of long-range interactions on the dielectric properties of water by computing the longitudinal component of the dipole density correlation function, (\tilde{m}*_{z}(k)\tilde{m}_{z}(k)), where m is the Fourier transform of the molecular dipole density and k=kz is along the z-axis. The dipole correlation function at the long-wavelength limit can be used to determine the dielectric constant of water.

Predicted dipole density correlations in reciprocal space, using short-range (SR) or long-range (LR) models and with or without massage passing layers (T=0 or T=1). The inset shows a zoom-in of the small k values.

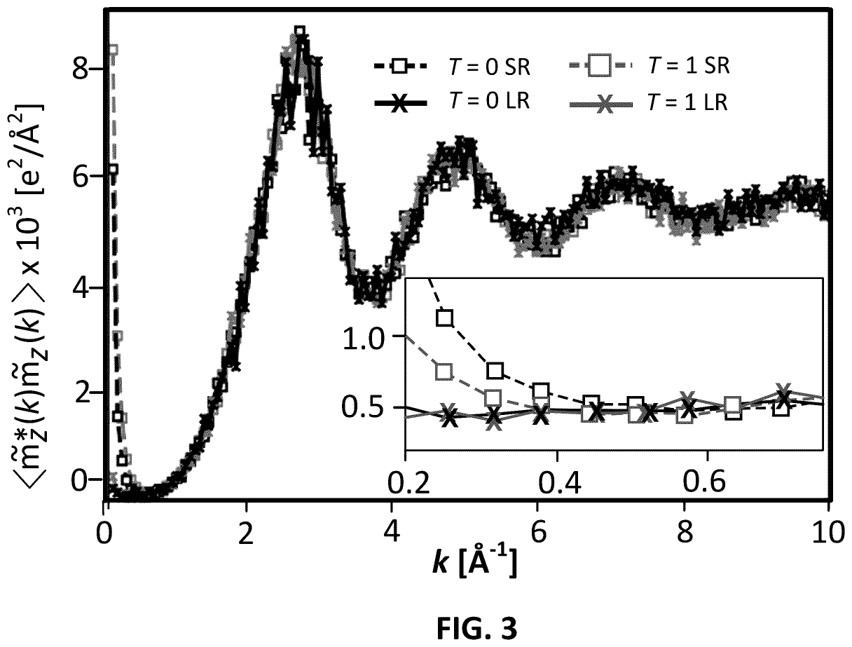

As shown in FIG. 3, while the dipole density correlation functions predicted by different MLIPs are in excellent agreement for most values of k, discrepancies emerge at long wavelengths. Specifically, the results from short-ranged models sharply increase as k→0. This divergence has also been observed in previous studies comparing SR and LR models. The divergence of the T=0 short-ranged MLIP appears at a k value corresponding to a real length scale of about 11 Å, while the T=1 SR model diverges at about 16 Å. Interestingly, these length scales, where divergence occurs, exceed the effective cutoff radius, suggesting that SR MLIPs may partially describe long-range effects beyond their cutoffs in a mean-field manner. Comparing the two SR MLIPs, the message passing layer delays the onset of divergence at small k values but does not eliminate it. In this scenario, only true LR models can adequately describe the dielectric response.

It is widely recognized that short-range MLIPs fall short in describing interfaces. To demonstrate the efficacy of the LES method for interfaces, the embodiments used a liquid-water interface dataset computed from Niblett, S. P., Galib, M & Limmer, D. T. “Learning intermolecular forces at liquid-vapor interfaces,” J. Chem. Phy. 155, (2021) (“Niblett”), computed with the revPBE-D3 functional. In one embodiment, a subset of 500 liquid-vapor interface configurations were selected, each containing 522 water molecules, far fewer than the approximately 17,500 training configurations used in Niblett to train the DeePMD (Deep Potential Molecular Dynamic) model, which may be attributed to the learning efficiency of CACE.

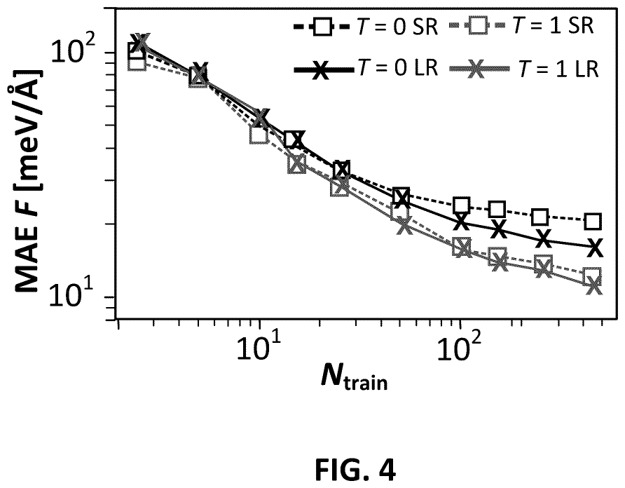

The embodiments employed the same settings for fitting the MLIPs as used for the bulk water dataset. The learning curves for forces are shown in FIG. 4. FIG. 4 shows learning curves on the liquid-vapor water interface dataset using the short-range (SR) and long-range (LR) models with no message passing (T=0) or one message passing layers (T=1).

The energy errors are very low, reaching less than 0.1 meV/atom in mean absolute error (MAE) for all models using just 50 training configurations. The force errors are also small, ranging from about 14 meV/Å to 27 me V/Å in MAE when trained on 90% of the dataset. The learning behavior is similar to that observed in the bulk water case: both message passing and long-range interactions enhance the accuracy of the MLIPs.

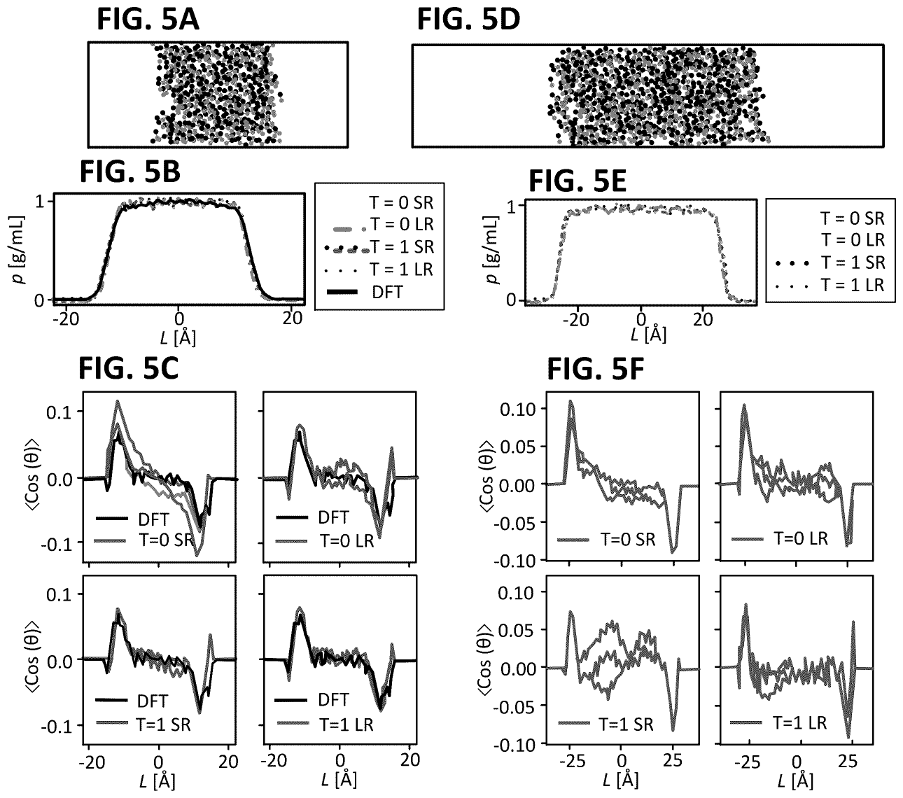

FIGS. 5A-5F shows a comparison of the interface properties of water predicted using short-range (SR) or long-range (LR) models and with or without massage passing layers (T=0 or T=1). FIG. 5A shows a snapshot of the thinner water slab configuration, 6B shows the water density profile, and 6C shows average cosine (c) the average cos(θ) for the angle formed by the water dipole moment and z-axis. DFT results are from Niblett. FIG. 5D, FIG. 5E, and FIG. 5F show the snapshot, water density, and (cos(θ)) for the thicker water slab, respectively.

For each of the T=0 SR, T=0 LR, T=1 SR, and T=1 LR models, the inventors trained three MLIPs using different random splits of 90% for training and 10% for testing. They then simulated the liquid-vapor interface at 300 K using both a thinner slab, shown in FIG. 5A, and a thicker slab of about double the thickness, shown in FIG. 5D. The resulting density profiles of the water slabs are shown in FIGS. 5B and 5E. All SR and LR models predict similar density profiles, and for the thinner slab, all models accurately reproduce the density profiles of the reference DFT water data.

In addition to density profiles, the inventors evaluated the orientational order profiles, shown in FIGS. 5C and 5F, by computing the angle, θ, between the dipole orientation of water molecules and the z-axis. For each model, the three different fits of MLIPs provide slightly different predictions, and the variances are larger for the SR models. At the interfaces, water molecules tend to form a dipole layer, which is screened by subsequent layers, ensuring that the bulk does not exhibit net dipole moments. However, without long-range interactions, this screening effect is not adequately captured, leading to extended dipole ordering into the bulk as seen in the T=0 SR model. The introduction of message passing (T=1 SR model) alleviates this issue at least for the thinner slab, but it also introduces an artifact: dipole ordering in the bulk along the opposite direction for the thicker slab. In contrast, the LR models recover the correct orientational order profiles, effectively capturing the screening effect and accurately representing the physical polarization behavior at the liquid-vapor interfaces.

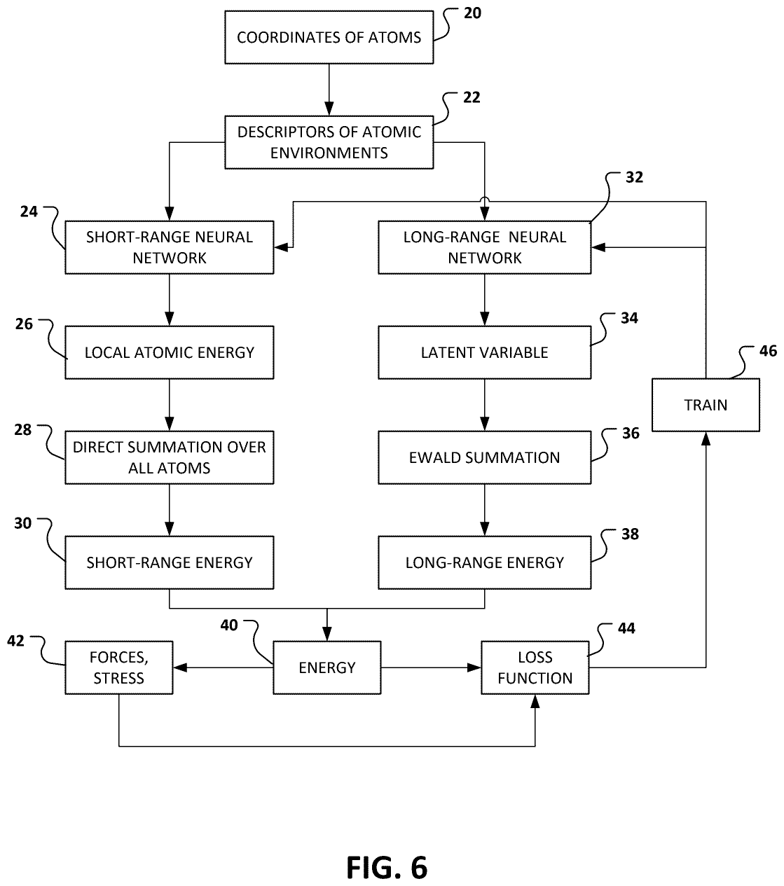

FIG. 6 shows a flowchart of an embodiment of a method of using machine learning to determine interatomic interactions of atomistic systems including long-range interactions. This method could be embodied by one or more processors, such as those discussed herein, executing code that causes the one or more processors to perform the various processes. The code may comprise machine-readable code compiled from programming languages such as Python, and Pytorch.

The process begins with the computation of the descriptors of atomic environments at 22 based on coordinates of atoms determined at 20. In one embodiment, at 24, a short-range neural network then operates on the atomic descriptors to determine the local atomic energy at 28, directly sum of the local energies at 28, to predict the short-range atomic energy associated with each atom at 30. The direct summation of the atomic energies of all atoms results in the short-range energy of the whole system.

In another embodiment, determining the short-range energy may occur within a host MILP system, described in more detail below. In yet another embodiment, determining the short-ranger energy may occur within the LES framework, but without a short-range neural network.

In any of the above embodiments, a long-range neural network configured at 32 maps invariant features of each atom using the latent variable at 34. The long-term energies are then summed using the Ewald summation of Eqn. 4 at 36 for periodic systems or using direct pair-wise summation for finite systems. This results in long-range energy at 38. The short-range and the long-range energies are then summed together at 40 and the forces on each atom and the stress of the system are determined at 42. These last two processes may occur within the LES system, or may occur at a host MILP. As will be discussed in more detail later, electrical response properties such as the Born Effective Charge (BEC) tensors can be computed as a separate module within the LES system. During training of the long-range neural network, the loss function 44 is computed based on one or more of the known and the predicted energy, forces, and stress of atomic configurations, and one or both neural networks are optimized according to the loss function to adjust their operations at 46.

The embodiments provide a simple and general method, the Latent Ewald Summation (LES), for incorporating long-range interactions in atomistic systems. Unlike existing LR methods, LES does not require user-defined electrostatics or dispersion baseline corrections, does not rely on partial charges or Wannier centers during training, and does not utilize charge equilibration schemes.

The results demonstrate that the LR model effectively reproduces correct dimer binding curves for pairs of charged, polar, and apolar molecules, long-range dipole correlations in liquid water, and dielectric screening at liquid-vapor interfaces. In contrast, standard short-ranged MLIPs, even when utilizing message passing, often yield unphysical predictions in these contexts. These challenges are common in atomistic simulations of molecules and materials, particularly in systems like water, which is ubiquitous in nature and essential to bio-logical processes. Moreover, long-range effects are crucial in aqueous solutions, organic electrolytes, and other interfacial systems.

The long-range MLIP incurs only a modest computational cost, roughly 5-10% more than that of the short-range version. Additionally, the LES method can be easily integrated into other MLIP frameworks, such as HDNNP, ACE, GAP, MTPs, DecPMD, NequIP, MACE, etc.

In one embodiment, LES can extend to modeling of responses of material and chemical systems to electric fields. The polarization P of a system underlies many electrical response properties including capacitance, dielectric constant, ferroelectricity, piezoelectricity, ionic conductivity, and infrared (IR) spectra. The Born effective charge (BEC) tensor Z* quantifies the variation in P due to an atomic displacement at position rᵢ of atom i:

$${Z}_{i αβ}^{*} = \frac{\partial {P}_{α}}{\partial {r}_{i β}} = \frac{\partial {ℱ}_{i α}}{\partial {ℰ}_{β}^{0}} , \qquad ( 5 )$$

where α and β label Cartesian directions. The second part of Eqn. (5) links the electrostatic force, Fᵢ on atom/resulting from an external electric field ξ⁰ to the system.

Modeling electrical response properties has long been a challenge. The Berry phase definition of the polarization of periodic insulators can be obtained from density functional theory (DFT) calculations. Density functional perturbation theory (DFPT) or the finite field method can be used to compute BECs and other derivatives of the polarization. However, the computational costs associated with such ab initio methods limit their applications to large systems or long timescales. On the other hand, fixed-charge or polarizable empirical force fields are cheap but may lack quantitative accuracy or transferability.

Standard machine learning interatomic potentials (MLIPs), which learn surrogate potential energy surfaces from quantum mechanical reference calculations, are typically short-ranged and do not explicitly consider electrostatics. Several approaches have been developed to incorporate long-range interactions, such as learning DFT-derived partial charges or maximally localized Wannier centers or employing long-range descriptors or long-range message-passing. LES discussed above learns long-range energy contribution E^{lr} by fitting the total potential energy E and atomic forces F of configuration as shown in Eqn. 4, in which the term the cell volume term Vis replaced with 2ξ₀V.

$${E}^{l r} = \frac{1}{2 {ℰ}_{0} V} {\sum }_{0 < k < {k}_{c}} \frac{{e}^{- {σ}^{2} {k}^{2} / 2}}{{k}^{2}} {\vert S ( k ) \vert}^{2} , \qquad ( 6 )$$

and the structure factor S (k) is given by:

$$S ( k ) = {\sum }_{i = 1}^{N} {q}_{i}^{l e s} {e}^{ik \cdot {r}_{i}} , \qquad ( 7 )$$

However, a natural inclusion of electric response directly within the MLIP frameworks is missing. Currently, P and BEC have to be learned separately as tensorial properties, e.g., directly predicting BEC or local contribution to the dipole moment of a molecule based on atomic local environments, or as the derivatives of the electric enthalpy. Conceptually, this is in contrast with the electronic structure picture of matter: electron density and nuclear positions fully determine how the system will interact with electric field.

The embodiments here show that polarization and BEC tensors can be naturally derived from long-range MLIPs within the LES framework. This enables accurate predictions of electrical response properties, such as IR spectra and conductivity, solely by learning from energies and forces. Importantly, it is straightforward to add an external electric field to MLIP-driven molecular dynamics (MD) simulations, enabling the exploration of electric-field-driven phenomena in various materials and molecules. The embodiments demonstrate this on a range of complex bulk systems, including molecular liquids, ionic liquids, superionic crystals, and ferroelectric materials.

Building on the pioneering Molecular Dynamics in Electronic Continuum (MDEC) model, the Coulomb interactions between the “free charges” of atoms are explicitly considered, while the rapidly responding background electrons are treated as a dielectric medium. The electrostatic field produced by the free atomic charge qᵢ of atom i can then be expressed as

$${ℰ}_{i} ( r ) = \frac{{q}_{i}}{4 π {ε}_{0} {ε}_{∞} {\vert r - {r}_{i} \vert}^{3}} ( r - {r}_{i} ) , \qquad ( 8 )$$

and the resultant electrical force between two atoms is given by:

$${ℱ}_{i j} = {ℰ}_{i} ( {r}_{i j} ) {q}_{i} , \qquad ( 9 )$$

where ϵ₀ represents the vacuum permittivity, and ϵ_{∞} is the high-frequency relative permittivity, also known as the static or electronic dielectric constant. This can be determined experimentally, such as from the square of the optical refractive index, or calculated using DPFT with a frozen nuclei.

The LES charges

$${q}_{i}^{l e s}$$

are interpreted as scaled charges.

$${q}_{i}^{l e s} = {q}_{i} / \sqrt{{ℰ}_{∞}} ,$$

acting both as the sources and receives of the electric field:

$${ℱ}_{i j} = \frac{{q}_{i}^{l e s} {q}_{j}^{l e s}}{4 π {ε}_{0} {r}_{i j}^{3}} {r}_{i j} \qquad ( 10 )$$

In the LES algorithm,

$${q}_{i}^{l e s}$$

are optimized to effectively describe the long-range component of the total potential energy and atomic forces. For modeling the energetics and dynamics of a system under no external field, these LES charges provide a self-contained description of electrostatic interactions, with no further adjustment needed. To model electrical response, however, the LES charges can be unscaled to recover the atomic charges qᵢ.

The polarization of a finite system such as a gas-phase molecule is

$$P = {\sum }_{i = 1}^{N} {q}_{i} {r}_{i} , \qquad ( 11 )$$

and the BEC Z* can be obtained by taking its derivative with respect to r:

$${Z}_{i αβ}^{*} = \frac{\partial {P}_{α}}{\partial {r}_{i β}} = {q}_{i} {δ}_{α , β} + {\sum }_{i = 1}^{N} {r}_{j α} \frac{\partial {q}_{j}}{\partial {r}_{i β}} . \qquad ( 12 )$$

As shown in the second part of Eqn. 12, the BEC tensor Z*ᵢ comes from two contributions, those of qᵢ, and the dependence of the charges on atomic positions.

For modeling either crystalline or disordered bulk systems, it is almost mandatory to apply periodic boundary (PBC) conditions. Importantly, the value of P cannot be uniquely defined for systems with PBC, according to the modern theory of polarization. To circumvent such ambiguity, the embodiments propose a generalized formulation of polarization P(k) under PBC:

$${P}_{α} ( k ) = {\sum }_{i = 1}^{N} \frac{{q}_{i}}{i k} exp ( i k {r}_{i α} ) , \qquad ( 13 )$$

where P_{α}(k) is the polarization along the α direction, k=2π/L_{α}, is the length of a periodic cubic cell, while the extension to triclinic cells is straightforward. At the limit of k→0, P(k) becomes the finite-system expression in Eqn. 11. The BEC tensor Z* of atom i can then be evaluated as

$${Z}_{i a β}^{*} = ℜ [ exp ( - ik {r}_{i α} \frac{\partial {P}_{α} ( k )}{\partial {r}_{i β}} ] . \qquad ( 14 )$$

The prediction of BEC enables the calculation of several electrical response properties. For instance, the current of the polarization of the system can be obtained as

$$J ( τ ) = {\sum }_{i = 1}^{N} {Z}_{i}^{*} ( t ) \cdot {v}_{i} ( t ) .$$

The current-current autocorrelation function encodes the ionic conductivity σ via the Green-Kubo formula,

$$σ = \frac{1}{3 V {k}_{B} T} {\int }_{0}^{∞} 〈 dt ( J ( 0 ) J ( t ) 〉 , \qquad ( 15 )$$

and the IR spectra via Fourier transform,

$$I ( ω ) ∝ {\int }_{0}^{∞} d t 〈 ( J ( 0 ) J ( t ) 〉 {e}^{- i ω t} . \qquad ( 16 )$$

Moreover, once BEC are computed using Eqn. (14), one can apply a real-valued constant electric field E0 to the system by adding the electrostatic force Fi on each atom using the second part of Eqn. (5) for the linear response regime, thus enabling constant-electric-field simulations under PBC.

The theoretical prediction for the IR spectrum of water is a classic problem but still not fully resolved, and more so with the presence of external electric fields. The embodiments herein used the Cartesian Atomic Cluster Expansion (CACE) potential as the short-ranged MLIP and LES as the long-range part and thereafter refer to this combination as CACE-LR. The RPBE-D3 bulk water dataset ((Revised Perdew-Burke-Ernzerhof density functional with Grimme's D3 dispersion coefficients) contains energies and forces of 654 configurations (90% train/10% test split) each of 64 water molecules. Even though one experiment used a compact CACE-LR model with a cutoff of 4.5 Å and no message passing, the test root mean square errors (RMSEs) of energy and forces (0.25 meV/atom and 21 meV/° A) are a fraction compared to the errors other approaches (0.8 meV/atom and 60 meV/° A).

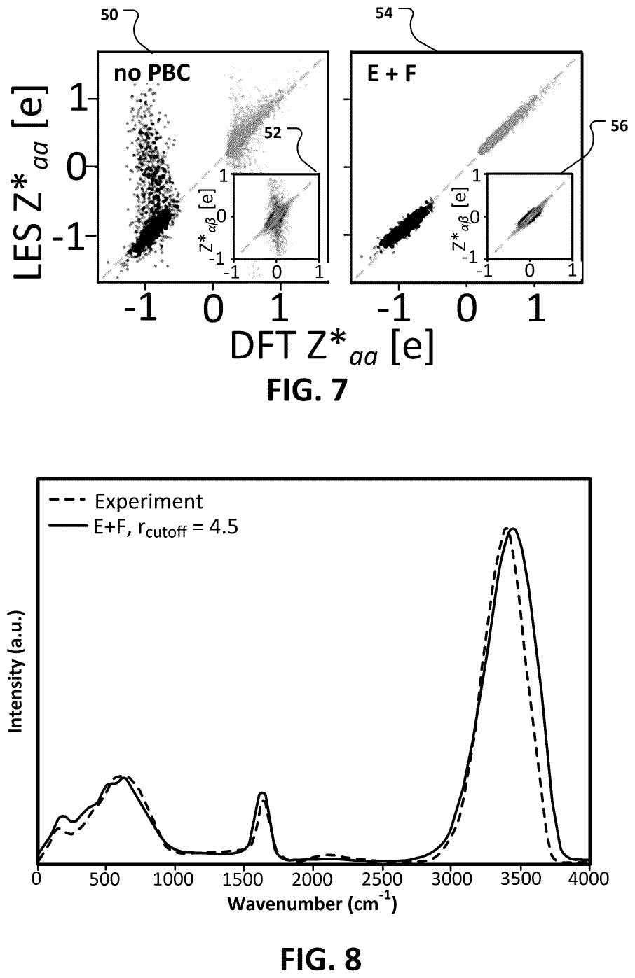

FIG. 7 shows an electrical response of the RPBE-D3 bulk water. It compares the Born effective charge tensors (Z*) computed from DFT and predicted using the LES method. The CACE-LES was trained on the energies (E) and forces (F) of the bulk water dataset. The main panels 50 and 54 compare the diagonal elements of the BEC

$$( {Z}_{αα}^{*} )$$

and the insets 52 and 56 show the off-diagonal elements

$$( {Z}_{a β}^{*} with α \neq β ) .$$

The left panel 50 corresponds to the LES BECs calculated assuming no periodic boundary conditions using Eqn. 12, and the right panel 54 shows the LES BECs computed using the generalized polarizability formulation obtained from Eqn. 13 and 14.

FIG. 8 shows the infrared absorption spectra of bulk liquid water in the absence of an external field calculated using CACE-LR with a 4.5 Å cutoff as the solid line. The dashed line shows the experimental IR spectrum obtained from John E. Bertie and Zhida Lan, “Infrared intensities of liquids xx: The intensity of the OH stretching band of liquid water revisited, and the best current values of the optical constants of H₂O(l) at 25° C. between 15,000 and 1 cm-1,” Applied Spectroscopy 50, 1047-1057 (1996). As can be seen, the IR spectra determined by CAC-LR closely matches the experimental data.

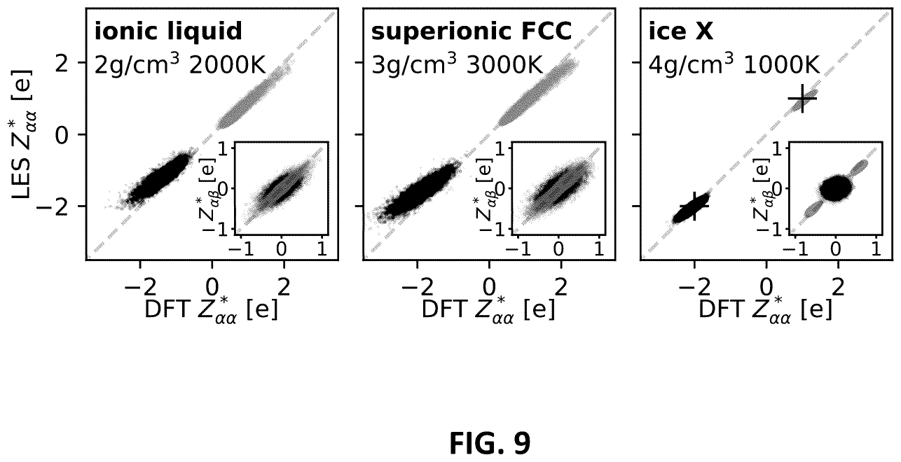

FIG. 9 shows a comparison of the BEC tensors (Z*) computed from DFT and predicted using the LES method, for 100 configurations of each phase at the specified conditions. As in FIG. 7, the main panels compare the diagonal elements of the BEC

$$( {Z}_{αα}^{*} )$$

and the insets show the off-diagonal elements

$$( {Z}_{a β}^{*} with α \neq β ) .$$

FIG. 9 shows that the predicted LES BECs agree closely with the ground-truth DFT values for the three distinct phases. At 2 g/cm³ and 2000 K, the liquid water is partially molecular and partially dissociated with frequent proton jumps. The diagonal BEC values for hydrogen atoms

$$( {Z}_{αα}^{H} )$$

can sometimes exceed the nominal charge of +1. At 3 g/cm³ and 3000 K, the FCC superionic ice exhibits even larger fluctuations of BECs for both hydrogen and oxygen. The anomalous BECs of hydrogen are again correlated to the O—H bond breaking and formation, and such events are more frequent. At 4 g/cm³ and 1000 K, the stable phase is ice X with a BCC lattice of oxygen atoms, and hydrogen atoms are evenly positioned between two neighboring oxygen atoms with straight O—H—O bonds. The diagonal values of BEC have very small fluctuations and are centered around the oxidation numbers of +1 for hydrogen and −2 for oxygen ions, shown as crosses in the right panel of FIG. 9. Intriguingly, the off-diagonal elements of BEC for H show two separate clusters at positive and negative values.

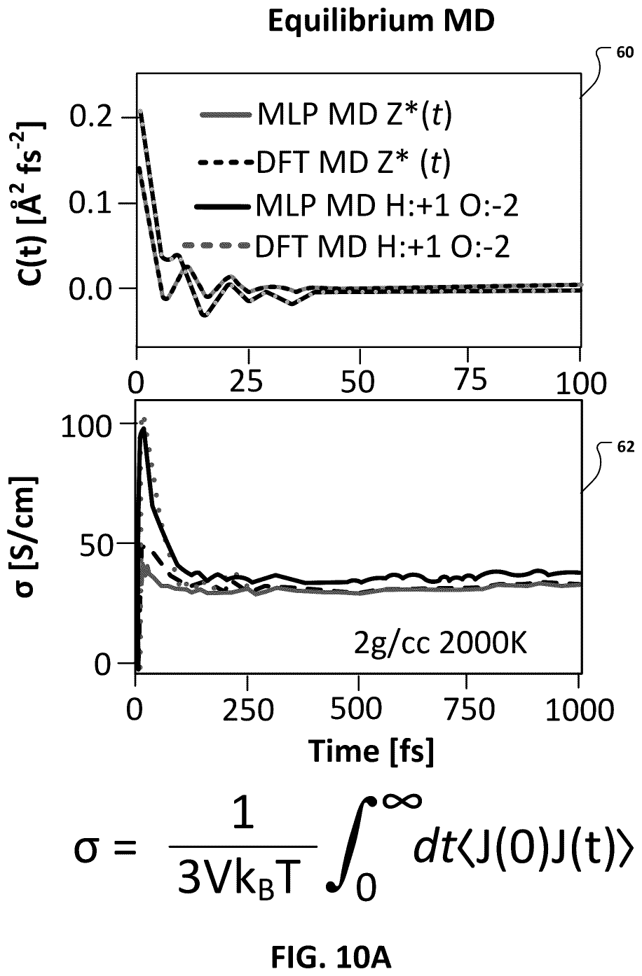

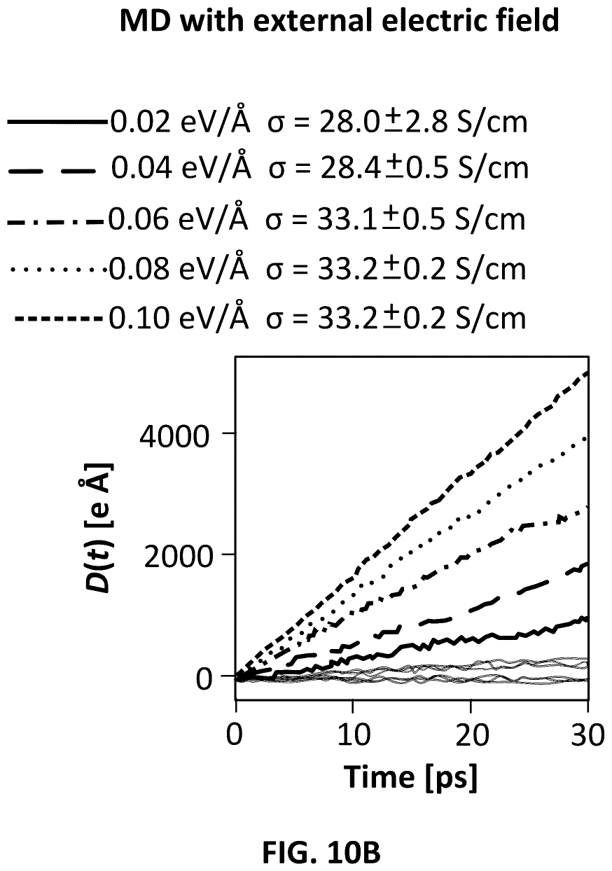

The ionic electrical conductivity σ is crucial for characterizing ionic and superionic systems. To compute σ at 2 g/cm³ and 2000 K, one experiment employed a CACE-LR model that was finetuned using energy, forces, and BEC values of 100 configurations at the same condition. The inventor performed an equilibrium MD simulation of 120 ps duration with 54 water formula units, and such system size was selected to be directly comparable to the previous DFT MD simulation from Martin French, Sebastien Hamel, and Ronald Redmer, “Dynamical screening and ionic conductivity in water from ab initio simulations,” Physical review letters 107, 185901 (2011), hereinafter “French, et. al.” The current-current correlation functions C(t)= [symbol] J(0)J(t) [symbol] /3e were calculated either using the time-dependent BEC tensor Z*(t) or the fixed nominal charges of q^{H}=+1 and q^{O}=−2. These correlation functions are shown at the top of FIG. 10A at 60. At short times they are in perfect agreement with a tour-de-force DFT MD and BEC calculation of 15 ps from French, et al.

The bottom graph 62 of FIG. 10A shows the σ values computed by integrating the corresponding C(t) functions using the Helfand-Einstein formula, a reduced-variance form of the Green-Kubo relation in Eqn. (15). Interestingly, the estimated σ with time-dependent BEC tensors (32±2 S/cm) is similar to the estimate of σ=37±2 S/cm with the constant q^{H}=+1 and q^{O}=−2. Such observation was also made in French, et. al., and was rationalized in Federico Grasselli and Stefano Baroni, “Topological quantization and gauge invariance of charge transport in liquid insulators,” Nature Physics 15, 967-972 (2019) from a topo-logical quantization argument albeit only for atomic liquids with all species adiabatically staying in the same motifs without changing oxidation states.

One can also compute σ from non-equilibrium MD simulations under external electric fields. FIG. 10B shows the total displacement of charges in the system over time under different values of the external field ξ⁰ along the z direction,

$$D ( t ) = {\sum }_{i}^{N} {q}_{i} ( {z}_{i} ( t ) - {z}_{i} ( 0 ) ) ,$$

computed using the constant charges q^{H}=+1 and q^{O}=−2. σ can be estimated from the slope of D(t) as σ= [symbol] D(t)/dt [symbol] Vξ⁰. Such σ values from these finite-electric-field simulations, as displayed in the legend at the top of FIG. 10B, are consistent with the equilibrium results, but have better statistical convergence and also avoid the problems associated with the Green-Kubo integration to the infinite time limit (Eqn. (15)).

These embodiments show that polarization and Born effective charge (BEC) tensors can be directly extracted from long-range MLIPs within the Latent Ewald Summation (LES) framework, solely by learning from energy and force data. Using this approach, the CACE-LR predicted the infrared spectra of bulk water under zero or finite external electric fields, and ionic conductivities of high-pressure superionic ice. The LES methodology extends the capability of MLIPs to predict electrical response-without training on charges or polarization or BECs- and enables accurate modeling of electric-field-driven processes in diverse systems at scale.

The LES framework discussed above overcomes limitations of those few methods that can learn long-range effects from standard datasets. These methods include Ewald message passing and RANGE and Coulomb-inspired long-range message-passing model FeNNix, and descriptor-based approaches like LODE and the density-based long-range descriptor. However, in these methods the long-range contributions are not explicitly related to electrostatics due to charged atoms, making it difficult to extract electrical response properties.

The Latent Ewald Summation (LES) framework discussed above overcomes these limitations by inferring atomic charges and the resulting long-range electrostatics directly from total energy and force data, without training on explicit charge labels. LES can thus be trained on any dataset used for short-ranged MLIPs. The inference of atomic charges not only enhances physical interpretability but also enables the extraction of polarization (P) and Born effective charges (BECs) as discussed above. These quantities allow computation of electrical response properties, including dielectric constants, ionic conductivities, ferroelectricity, and infrared (IR) spectra, and also enable MLIP-based molecular dynamics under applied electric fields.

In some embodiments herein, LES becomes a universal electrostatics augmentation framework for short-ranged MLIPs. Unlike prior methods that are tightly integrated with specific architectures, LES is implemented as a standalone library that can be combined with a wide range of MLIP models. The LES framework can be implemented as code patches for several MLIP packages, such as MACE, NequIP, CACE, and MatGL as examples, enabling seamless integration. The discussion below provides benchmarks and comparison of LES-augmented models across diverse systems with the baseline short-ranged MLIPs, demonstrating improved accuracy and correct long-range electrostatics through the inference of BECs.

Additionally, to demonstrate scalability to large, chemically diverse datasets, in one experiment MACELES-OFF, an MLIP with explicit long-range electrostatics for organic molecules, was trained using the SPICE dataset. The experiment found that MACELES-OFF outperforms its short-range counterpart, MACE-OFF, and accurately predicts BECs, despite never being trained on charge or polarization data.

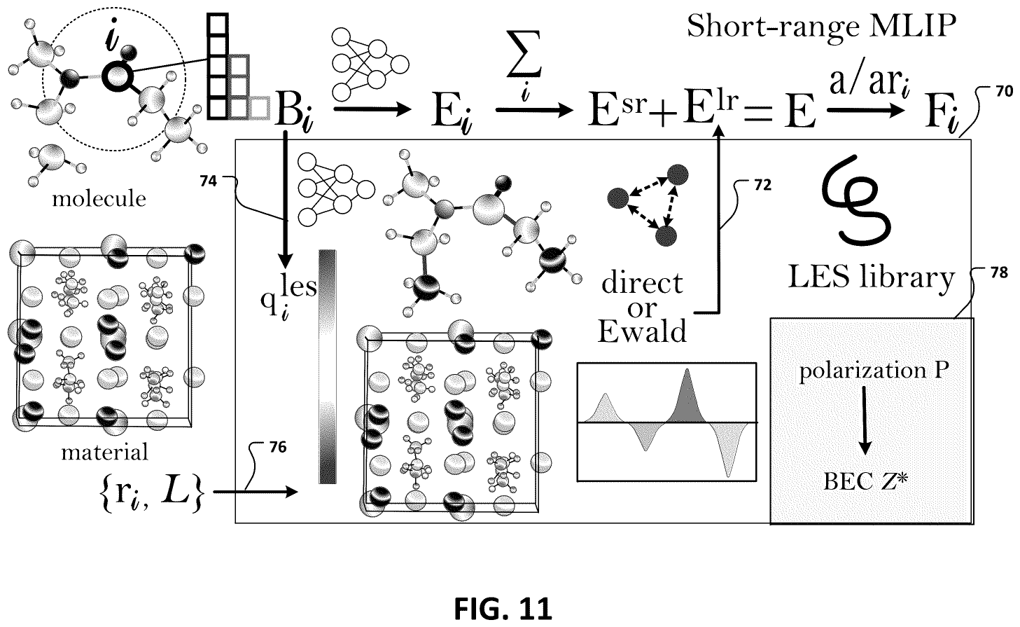

The integration of the LES library with a host MLIP is illustrated in FIG. 11. The region outside box 70 outlines the standard workflow of a short-range MLIP. Given a molecular or periodic system, the base MLIP computes invariant and/or equivariant features for each atom i, based on either local atomic environment descriptors or message-passing architectures. The local invariant descriptors Bᵢ are mapped via a neural network to atomic energies Ei, which are then summed to obtain the total short-range energy

$${E}^{s r} = {\sum }_{i = 1}^{N} {E}_{i} .$$

Box 70 in FIG. 11 shows the LES module, which in one embodiment was written in Pytorch, and the black arrows 72, 74, and 76, that cross into box 70 indicates communications between LES and the host MLIP. The LES module can either take the Bᵢ features to predict the latent charge of i of each atom,

$${q}_{i}^{l e s} ,$$

via a neural network, or this charge prediction part can happen inside the MLIP and be passed to LES. These q^{les} charges are then used to compute the long-range energy contribution E^{lr}. For periodic systems, the Ewald summation used is shown in Eqn. 6, with Eqn. 7. For finite systems, the long-range energy is computed using the pairwise direct sum:

$${E}^{l r} = \frac{1}{2} \frac{1}{4 π {ε}_{0}} {\sum }_{i = 1}^{N} {\sum }_{j = 1}^{N} [ 1 - φ ( {r}_{l j} ) ] \frac{{q}_{i} {q}_{j}}{{r}_{i j}} , \qquad ( 17 )$$

Where the complementary error function

$$φ ( r ) = erfc ( \frac{r}{\sqrt{2 σ}} ) .$$

The E^{lr} computed in LES is returned to the host MLIP package to be added to the total potential energy E=E^{sr}+E^{lr}. Inside the host MLIP, forces and stresses are obtained through automatic differentiation of the total energy with respect to the atomic positions and cell strain, respectively. The training procedure remains unchanged from the original MLIP package, using conventional loss functions for energy, forces, and stresses with user-defined weights.

Optionally, as indicated by the shaded area 78 in FIG. 11, LES can predict Born effective charge tensors, as discussed above with reference to Eqns. 6-14. In brief, for a finite system such as a gas-phase molecule, the BEC for atom i is found by Eqn. 12. For a homogeneous bulk system under PBCs, the BEC can be found by Eqn. 14.

In some embodiments, LES has been integrated into several representative MLIPs with distinct architectures, briefly described here. NequIP is a message passing neural network (MPNN) with E(3)-equivariant convolutions, and it typically uses 3-5 message passing layers with a perceptive field that can be as large as about 20 Å. CACE is based on atomic cluster expansion (ACE). With one layer (nₗ=1), CACE is a local atomic descriptor-based model employing polynomial expansions of atomic clusters with body order v in Cartesian coordinates. When v=2, three-body interactions are captured and (C) ACE has the same expressive power as earlier MLIP methods including HDNNPs, Gaussian Approximation Potentials (GAP), and DeepMD. MACE is an MPNN that combines equivariant representations with the physically grounded structure of atomic cluster expansions. Because of the high-body-order messages, typically only one message passing layer on top of the base ACE layer is needed. MatGL is a graph deep learning library for materials modeling.

Instead of using equivariant message passing, MatGL utilizes node and line graph representations to incorporate three-body interactions, such as M3GNet and CHGNet. These models span a wide range of architectural paradigms—descriptor-based versus message-passing, invariant versus equivariant representations—and demonstrate that LES can be universally incorporated without requiring architecture-specific modifications.

The discussion below shows results of benchmarking the performance of the aforementioned MLIP architectures (MACE, NequIP, CACE, and CHGNet) with and without LES augmentation across three distinct systems. This exemplifying the key challenges and practical importance of long-range electrostatic interactions. In the bulk water system, while short-range interactions play an important role in the hydrogen-bond network and structural properties, long-range electrostatics are crucial for its dielectric response and interfacial behavior. The polar dipeptides represent gas-phase systems with strong multipole interactions. In addition to standard metrics such as energy and force root mean square errors (RMSEs), the discussion also provides an evaluation of the prediction of physical observables (BECs and adsorption energies) not in the training set.

The baseline and LES-augmented MLIPs were trained using the energy and forces from the RPBE-D3 bulk water dataset, which contains 604 training and 50 test configurations, each of 64 water molecules. The configurations were generated from MD trajectories at temperatures ranging from 270 K to 420 K at water density under room temperature (≈997 kg/m³), using an on-the-fly learning scheme. BEC values were also used for an addition 100 snapshots of bulk water at experimental density and room temperature for testing LES, computed also from the RPBE-D3 DFT. The experimental high-frequency permittivity (ϵ∞=1.78) of water was assumed in the prediction of BECs based on Eqn. 14.

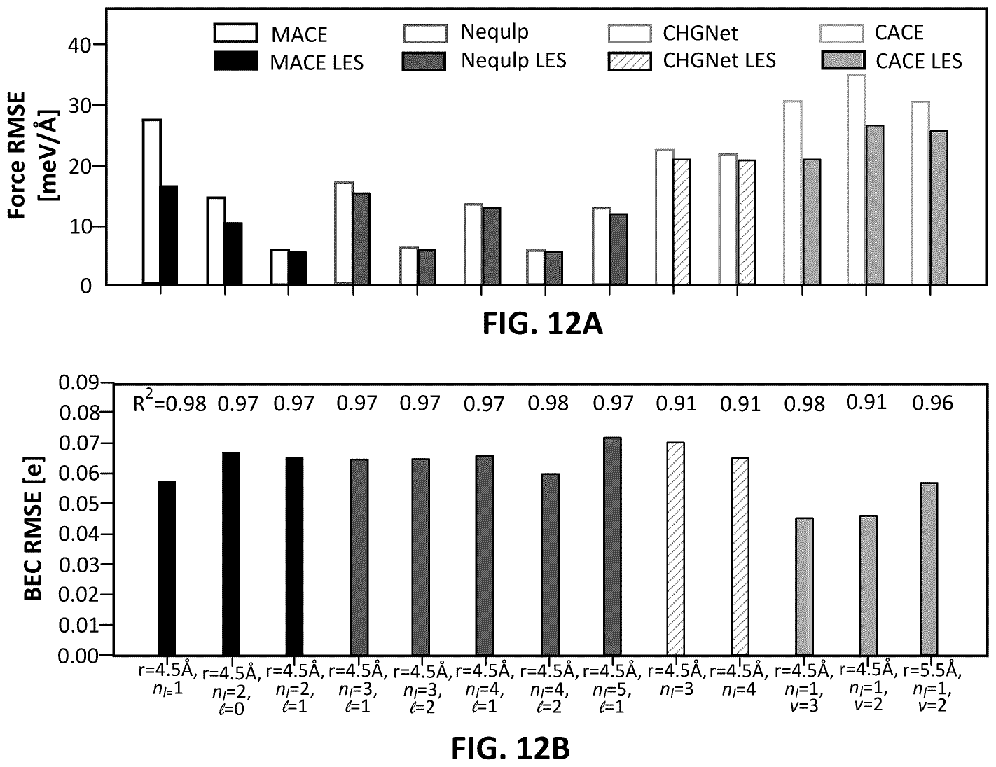

FIG. 12A shows force RMSEs for each MLIP architecture, as the energy RMSE values remain uniformly low (0.1-0.3 me V/atom) except for CHGNet (0.8-0.9 me V/atom) and are thus omitted here. For the baseline MLIPs as indicated by the hollow bars in FIG. 12A one can observe the usual trend typically expected from short-ranged models. Without message-passing layers (nₗ=1), increasing the cutoffs (r) improves the accuracy (e.g., comparing CACE v=2 r=4.5° A and r=5.5 Å models), and so does boosting the body order (CACE r=4.5 Å v=2 and v=3). More layers (n) effectively increase the perceptive field of the short-ranged MLIPs and reduce the errors, for both equivariant MPNNs (MACE and NequIP) and the invariant CHGNet. Increasing the rotation order (l) in E(3) equivariant representations of messages also helps the accuracy, as seen in both MACE and NequIP models.

The solid bars in FIG. 12A show the force RMSEs for the LES-augmented models. Comparing the solid bars with the hollow ones, LES reduces the errors for all models, while the extent of improvement is somewhat dependent on the architecture of the short-ranged baseline. For this bulk water dataset, LES benefits most of the MLIPs with a smaller effective perceptive field. That is, the MACE and the CACE models without message-passing (nₗ=1) see the largest force error reductions, and the NequIP and CHGNet with several message-passing layers have modest reductions. The other hyperparameters of the base MLIPs, v and l, do not seem to have a strong influence on the efficacy of LES.

The embodiments shown that LES can capture the correct electrostatic interactions and predict physical atomic charges. The BEC benchmark shown in FIG. 12B presents the RMSEs of the BECs compared to the DFT calculated values. Importantly, for all MLIPs, regardless of model architecture, hyperparameters, or effective cutoffs, LES can accurately predict the BECs. No obvious correlation was found between the accuracy of the BEC prediction and the baseline MLIP architecture, nor with the force RMSE errors. However, there is a weak inverse correlation with the reduction in force RMSE errors. This suggests that LES is a robust approach to infer BECs, regardless of the underlying model performance. The BECs are not only sensitive indicators of the correct electrostatics but are also useful in atomistic simulations for electrical response properties. For instance, the above discussion showed that such prediction of BECs can enable accurate prediction of water IR spectra under zero or finite external electric fields.

LES can also enhance other MILPs, including those for dipeptides. The baseline and LES-augmented MLIPs were trained using energy and forces from a dataset of polar dipeptide conformers selected from SPICE, which contains 550 configurations (90% train/10% test split) For testing LES, the models computed BEC values at the ωB97-mD3(BJ)/Def2SVP level of theory. As these systems are in vacuum, the high-frequency permittivity is ϵ∞=1, and one can use Eqn. 12 directly when predicting BECs using LES.

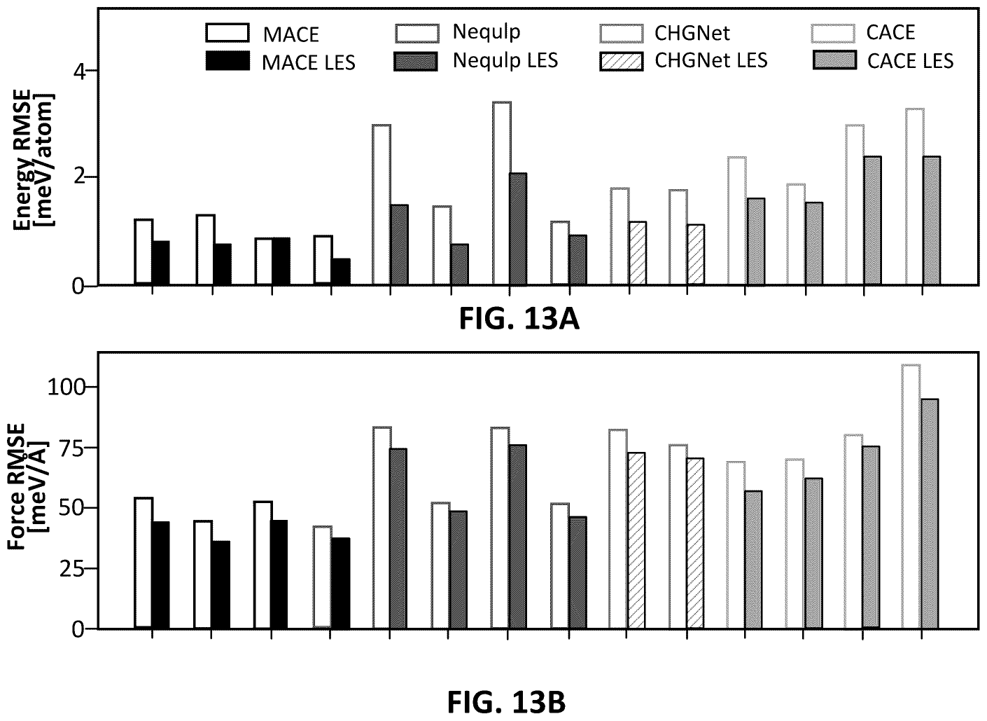

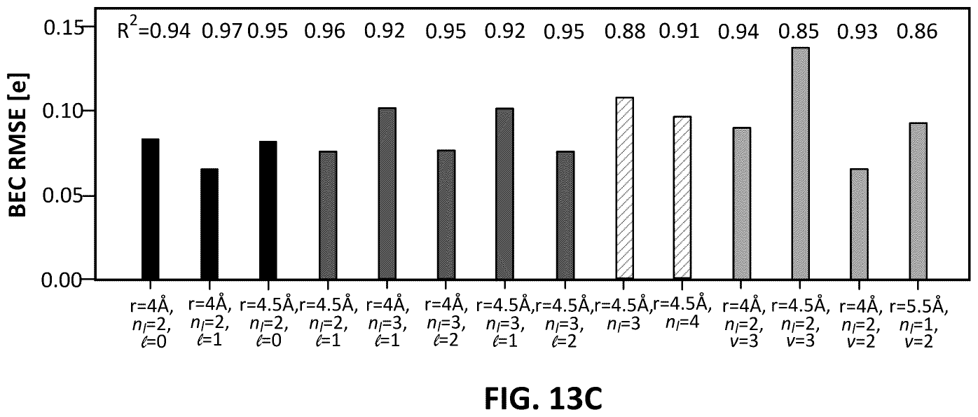

FIGS. 13A and 13B show the energy and force RMSE values for each MLIP architecture. For the baseline MLIPs indicated by the hollow bars, one can again observe the usual trends that increasing body order (CACE r=4.5 Å v=2 and v=3), and the number of layers (CHGNet r=4.5 Å nₗ=3 and nₗ=4) lead to improved accuracy. Additionally, increasing l improves both MACE and NequIP models.

The solid bars in FIGS. 13A and 13B represent the energy and force RMSEs for the LES-augmented models. Comparing the solid and hollow bars, one finds again that LES augmentation consistently reduces both energy and force prediction errors across all baseline MLIPs, regardless of their specifics. Hyperparameters such as r and v do not appear to strongly influence the effectiveness of LES, nor do the perceptive fields of baseline models. This implies that LES provides an improved molecular representation on top of message passing.

As is seen in FIG. 13C, LES-augmented models all show excellent agreement with DFT reference values for BEC predictions (up to R2=0.97). There are no clear-cut correlations between BEC and force or energy RMSE improvement, showing that LES remains a robust way to compute charge regardless of the relative performance of the baseline model. As shown above, the ability of LES to capture electrostatic interactions also extends to dipole moments, quadrupole moments, and IR spectra. Electrostatics strongly affects peptide backbone conformations in dipeptides, which suggests LES augmentation can be helpful for protein structure, folding, binding, and other biological functions.

In the above, LES was benchmarked on specific systems and relatively small datasets. The discussion now turns to whether the long-range correction scheme works at scale, for large and chemically diverse datasets. This is not only relevant for validating the scaling capability of the method but is practically important for constructing emerging “foundation models” that work across the periodic table.

The MACE-OFF23 (small(S), medium (M), and large (L)) is a recent set of short-range transferable machine learning force fields for organic molecules, which are based on the MACE architecture and trained on finite organic systems: small molecules of up to 50 atoms from about 85% of the SPICE dataset version 1 with a neutral formal charge and containing ten chemical elements Hydrogen, Carbon, Nitrogen, Oxygen, Fluoride, Phosphorous, Sulfur, Chlorine, Bromine, and Iodine, as well as 50-90 atom molecules randomly selected from the QMugs dataset. The dataset contains the energies and forces computed at the ωB97M-D3(BJ)/def2-TZVPPD DFT level of accuracy. MACELES-OFF (the LES version) model was trained based on the same training/validation split of MACE-OFF23.

The main purpose here is to demonstrate the effect of the LES augmentation compared to the baseline model, rather than fitting the most accurate model possible. The MACELES-OFF model trained used hyperparameters of cutoff radius r=4.5 Å, chemical channels k=192, the order of the equivariant features [symbol] =1, and float32 precision. The comparison of these hyperparameters with the original MACE-OFF23 models is presented in Table II. Compared to the MACE-OFF23(S), the MACELES-OFF has the same r but higher k and [symbol] . Thanks to its lower precision as well as little overhead from LES, the MACELES-OFF is about as fast as the MACE-OFF23(S), and much faster than the MACE-OFF23(M) and MACE-OFF23 (L) models.

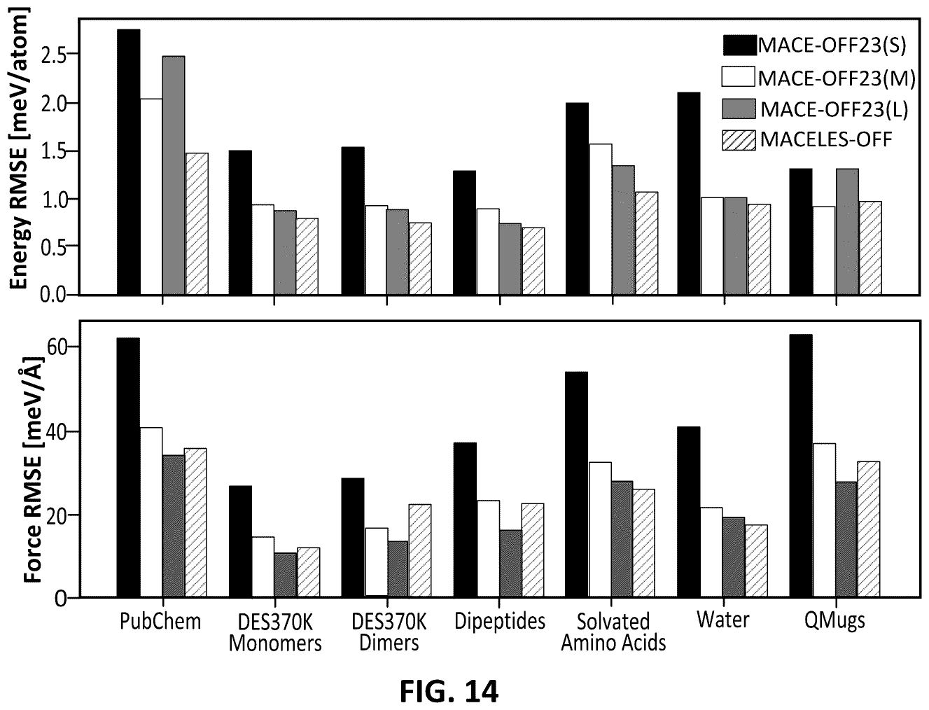

FIG. 14 compares the RMSE values for energy and force for the three original MACE-OFF23 (S, M, L) and MACELES-OFF, on different subsets of test configurations. Overall, the MACELES-OFF shows RMSEs comparable to the MACE-OFF23(L) that uses a larger cutoff r=5 and higher [symbol] =2. Compared to the MACE-OFF23(S) model that shares the same cutoff, the errors are about halved. Amongst all the subsets, the MACELES-OFF shows particularly better accuracy or water clusters, solvated amino acids, and dipeptides, which may indicate that the model is well-suited for simulating biological systems.

To test whether LES is able to extract the correct electrostatics if the model is able to infer the dipole moments μ (same as the polarization of finite systems) and BECs was investigated. For about 50 configurations in each of the test subsets, the reference BECs and dipole moments were calculated at the ωB97m-D3(BJ)/Def2SVP level of theory. The results show good agreement between the reference and the predicted dipole moments u, and a comparison of the DFT and the BECs computed by LES via taking the derivative of the predicted μ as in Eqn. 12, show broad agreement in both the on- and off-diagonal components over the broad range of elements and chemical species contained in the test set. These agreements demonstrate that accurate inference of dipole moments and BECs is achievable in foundation-like models trained only on energy and forces.

A key requirement for organic force fields is the accurate description of bulk water. Note that the training set only contains small, non-periodic water clusters; the application to the simulations of bulk liquid is in itself a generalization task.

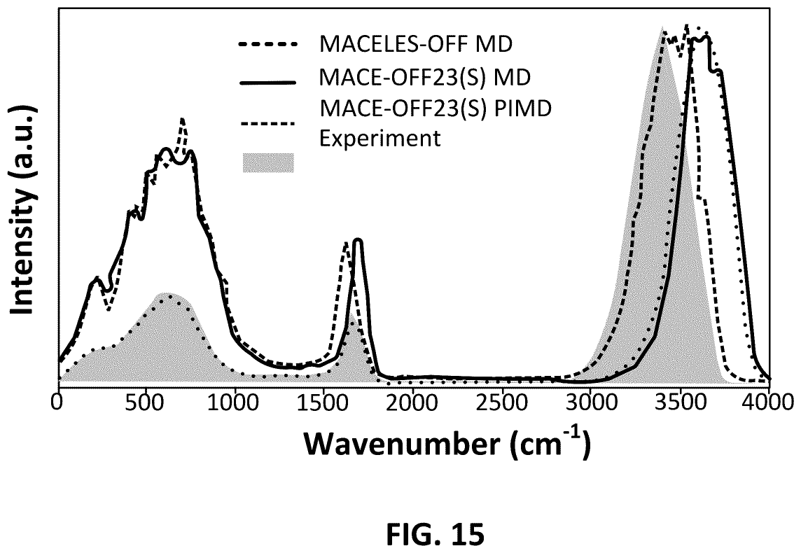

Equilibrium NVT molecular dynamics simulations were performed of bulk water at 300 K and experimental density. An IR spectrum from the MD trajectory was computed using predicted BECs, as illustrated in FIG. 15. For comparison, the IR spectrum predicted using MACE-OFF23(S) was included, computed from the autocorrelation function of the time derivative of the total dipole moment predicted using a separate MACE-OFF23-μ model along classical MD trajectories, as well as experimental results. The intramolecular bending mode (≈1640 cm-1), the intermolecular low-frequency vibration band (≈650 cm-1), and the hydrogen-bond translational stretching mode (≈200 cm-1) are all well-captured by the MACELES-OFF, whereas the MACE-OFF23(S) classical MD result reproduces the band shapes but not the intensities. The predicted intramolecular vibrational mode (OH stretching band ≈3400 cm-1) is blue-shifted relative to the experiment, which is due to the use of classical MD without nuclear quantum effects (NQEs). To illustrate the impact of NQEs, the IR spectrum obtained from the MACE-OFF23(S) is shown with path-integral MD (PIMD) simulations within the PIGS approximation. Incorporating NQEs brings the MACE-OFF23(S) frequencies into close agreement with experiment, especially by correcting the blue shift in the OH stretching region.

The temperature dependence of liquid water density was simulated based on NPT simulations conducted at 1 atm. Comparative analysis demonstrates that MACELES-OFF achieves superior density prediction, exhibiting about 10% overestimation of liquid water density compared to the original 18% overestimation reported by the MACE-OFF23(M) model. This improvement highlights the importance of long-range dipole-dipole interactions in predicting bulk properties such as density. One should also note that the MACE-OFF model can predict water density closer to experimental values by further increasing the cutoff to 6 Å, which corresponds to a perceptive field of 12 Å.

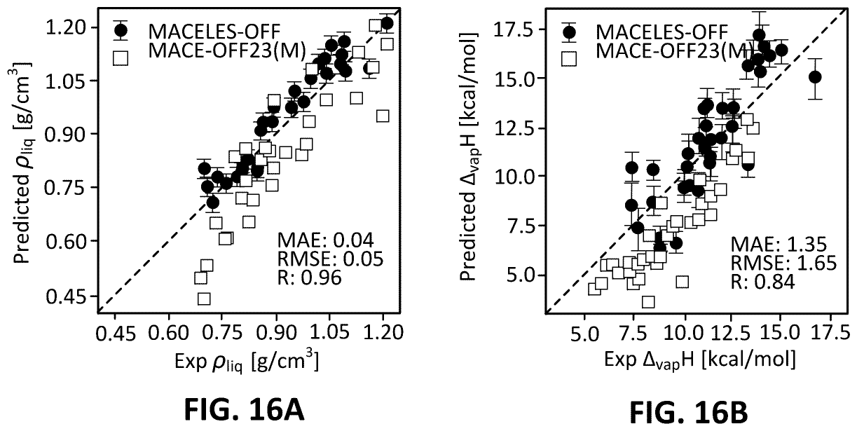

The performance of MACELES-OFF was investigated in predicting condensed-phase properties such as densities (ρ_{liq}) and enthalpy of vaporization (ΔᵥₐₚH) under ambient conditions (298 K and 1 atm). FIG. 16A shows a comparison for ρ_{liq}, and FIG. 16B shows ΔᵥₐₚH. Reproducing such properties was observed to present challenges for short-ranged MLIPs. A comprehensive test set of 39 molecular liquids with boiling points greater than 320 K was selected, referencing the MACEOFF benchmark. This set encompasses diverse chemical classes highly relevant to chemistry and biology, including alcohols, amines, amides, ethers, aromatics/hydrocarbons, ketones/aldehydes, thiols/sulfides, and other functionalized compounds.

The MACELES-OFF model demonstrated superior accuracy in predicting liquid density and enthalpy of vaporization compared to the MACE-OFF23(M). For liquid density, the MACELES-OFF achieves an MAE of 0.04 g/cm3 and RMSE of 0.05 g/cm3, which represents approximately half the error values of the MACE-OFF23(M) (MAE: 0.09 g/cm3, RMSE: 0.15 g/cm3). These low error values, coupled with a stronger correlation with experimental data (R=0.97) compared to the MACE-OFF23(M) model (R=0.89), indicate that the MACELES-OFF accurately learned both short- and long-range intermolecular interactions.

Similarly, regarding the calculations of ΔvapH, the MACELES-OFF model yields a MAE of 1.32 kcal/mol and RMSE of 1.62 kcal/mol with a correlation of R=0.84 and thus outperforms the MACE-OFF23(M) model that has an MAE (2.18 kcal/mol) and RMSE (2.53 kcal/mol) with R=0.87. Moreover, while the MACE-OFF23(M) model exhibits a systematic ΔᵥₐₚH offset of about 2 kcal/mol, which is largely eliminated in the MACELES-OFF prediction.

To probe the influence of the long-range interactions in MACELES-OFF on protein-protein and protein-water interactions, two biological systems were studied: solvated alanine dipeptide and the 1FSV protein.

For the alanine dipeptide in water, free energy surface (FES) was computed using well-tempered metadynamics simulations in explicit solvent. The AMBER ff99SB-ILDN force field exhibits an FES with four local minima, consistent with previous studies: antiparallel β-sheet (αβ), polyproline II (PPII), right-handed α-helix (α-H(R)), and left-handed α-helix (α-H(L)). In comparison, MACELES-OFF displays the deepest minimum at α-H(R). The free energy difference between α-H(R) and the second minimum (αβ) is approximately 1.5 kcal/mol, while the difference with PPII is around 3.0 kcal/mol, consistent with the relative ordering of minima and similar to the relative free energies reported for MP2/cc-pVTZ level with implicit solvent. Compared to the recent FENNIX-Biol model that includes long-range interactions, nuclear quantum effects, and is trained on the high-level SPICE2(+)-ccECP dataset, MACELES-OFF yields a very similar overall shape of the FES. Interestingly, the right-handed α-helix region does not appear as a clear minimum but rather as a shallow valley on the FES by both AMBER ff99SB-ILDN or AMBER99, likely due to insufficient treatment of water-protein interactions, an issue well tackled by MACELES-OFF.

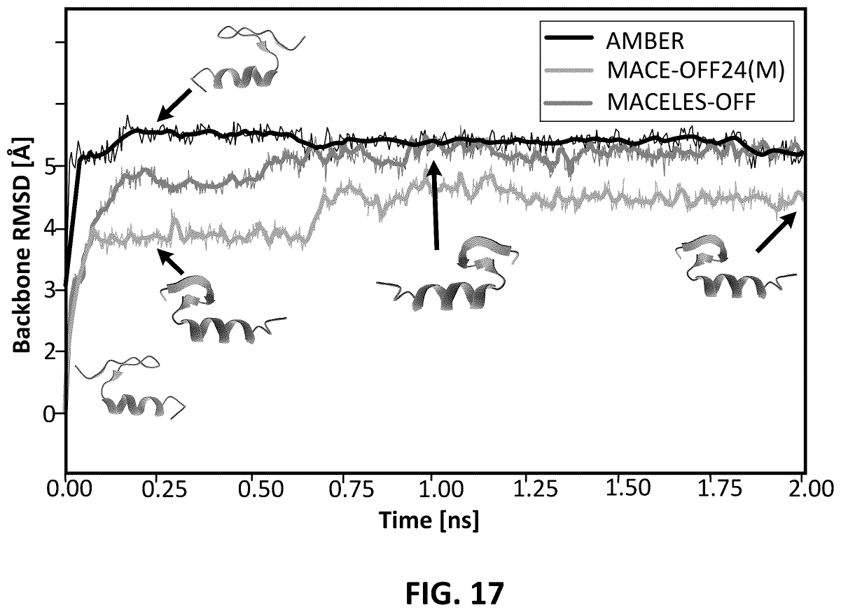

For the 1FSV protein, 2 ns MD simulations were performed in vacuum for all three models, starting from the crystallographic PDB structure. The 1FSV protein poses a significant challenge due to its 10 positively and 5 negatively charged groups. As shown in FIG. 17, both MACELES-OFF and MACE-OFF24 (M) began folding the protein into a more compact conformation, characteristic of gas-phase behavior. However, their trajectories diverged over time. MACELES-OFF exhibited more stable dynamics, remaining close to AMBER ff99SB-ILDN, with a root-mean-square deviation (RMSD) of 5.14 Å with respect to the 1FSV PDB structure, just 0.085 Å lower than AMBER's 5.22 Å. In contrast, MACE-OFF24 (M) showed continued RMSD drift and over-compaction, reaching 4.43 Å.

Further structural analysis confirmed these trends through the calculation of salt bridges and hydrogen bond networks. MACE-OFF24 (M) exhibited the highest number of salt bridges (159, +35% vs. PDB) and hydrogen bonds (286, +55%), indicating an over-collapsed structure. By comparison, MACELES-OFF formed 149 salt bridges and 263 hydrogen bonds, values more consistent with AMBER (143 and 258, respectively).

Overall, the results above suggest that MACELES-OFF can provide a good description of the FES of a small peptide solvated in water. Comparing MACELES-OFF and MACEOFF for the folding of 1FSV in vacuum, long-range electrostatics play a critical role in governing the dynamics and structural stability of the protein. These findings underscore the importance of including long-range interactions in simulations of biomolecular systems.

In this manner, LES comprises a “universal” augmentation framework for adding long-range electrostatics to short-range MLIPs. It is universal in three ways. First, LES can work together with many short-ranged MLIPs in an architecture-agnostic way as long as there are local invariant features for atoms. LES was patched to MACE, NequIP, CACE, and MatGL. Interestingly, LES works well with the CACE models with three-body interactions v=2, which are mathematically equivalent to the earlier generation of MLIPs (e.g., HDNNPs, Gaussian Approximation Potentials, and DeepMD). This suggests that LES will also complement well those lower-body-order MLIP methods. The LES-augmented HDNNPs would indeed be quite similar to the third-generation HDNNPs (3G-HDNNPs), except that not explicitly trained on partial DFT charges. The fact that 3G-HDNNPs have poor performance in many systems may be attributed to the explicit charge training, rather than inferring from energy and forces.

Second, the LES augmentation is useful across a wide range of systems. Across the benchmarks above of bulk water, and dipeptides, the inclusion of LES yields consistent, architecture-agnostic improvements. Even when the reduction of energy and force RMSEs is modest, LES significantly improves physical observables. For example, in the water and dipeptide set, LES achieves accurate BEC predictions despite training exclusively on energy and forces. BECs are not only well-defined physical quantities that serve as sensitive probes of electrostatics but are also critical in calculating a range of electrical response properties such as dielectric constants, ionic conductivities, and dipole correlation functions.

Third, LES can be scaled to large datasets with chemical diversity and can be used to train universal MLIPs. As a demonstration, the MACELES-OFF model shows better accuracy compared to the short-ranged baseline models, encodes the correct electrostatics, and exhibits better transferability. For instance, the MACE-OFF23 models show an amazingly wide range of accurate predictions across small molecules, biological systems, and molecular crystals, but they are less accurate in predicting the densities and heats of vaporization of molecular liquids. Such shortcomings are attributed to the lack of long-range interactions. Indeed, incorporating LES effectively solved such issues and provides much improved predictions for the liquids. In addition, electrical response properties such as IR spectra are readily available.

Additionally, using LES only requires standard energy and force labels. This is an advantage for scaling up the training of universal MLIPs with large-scale datasets, as most such datasets, especially of extended systems, do not contain explicit polarization or charge information. However, the dipole moments of gas-phase molecules are more readily available, and in principle one can include these in the training of partial charges under the LES framework, by adding a dipole loss function as in AIMNET2, SO3LR, and MPNICE.

To conclude, by incorporating long-range electrostatics and without training on labels other than energy, forces, and in some cases, stresses, the LES method addresses a core limitation of current MLIPs. The LES library works as a drop-in patch for many short-ranged MLIPs and demonstrates reliable and consistent performance across a wide range of architectures, chemical system types, and data sizes.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of this disclosure have been illustrated and described for purposes of illustration, it will be understood that various modifications may be made without departing from the spirit and scope of the invention. Accordingly, the invention should not be limited except as by the appended claims.

What is claimed is:

1. A computing device usable in an atomistic system, comprising:
one or more processors configured to execute code that cause the one or more processors to:
compute descriptors of atomic environments of all atoms in the atomistic system;
determine a short-range energy for each atom;
define a long-range neural network to map invariant features of each atom to one or more hidden variables;
perform an Ewald summation on the hidden variables to determine a long-range energy of the system;
sum the short-range energy and the long-range energy to determine total energy of the system.

2. The computing device as claimed in claim 1, wherein code that causes the one or more processors to determine the short-range energy comprises code that causes the one or more processors to define a short-range neural network to determine local atomic energy for each atom and sum the local atomic energy for all atoms to determine the short-range energy.

3. The computing device as claimed in claim 1, wherein the one or more processors are further configured to execute code that causes the one or more processors to determine a loss function between a known value and predicted value of one or more of energy, forces, and stress.

4. The computing device as claimed in claim 3, wherein the one or more processors are further configured to use the loss function to adjust operation of the neural network.

5. The computing device as claimed in claim 1, wherein the one or more processors are further configured to execute code that causes the one or more processors to predict Born effective charge (BEC) tensors for each atom.

6. The computing device as claimed in claim 4, wherein the one or more processors are further configured to execute code that causes the one or more processors to use the BEC tensors to determine electrical response properties of the atoms comprising one or more of capacitance, dielectric constant, ferroelectricity, piezoelectricity, ionic conductivity, and infrared spectra.

7. The computing device as claimed in claim 1, wherein the invariant features include one or more of local atomic environment descriptors, atom centered symmetry functions, smooth overlap of atomic positions, and latent invariant features.

8. The computing device as claimed in claim 1, wherein the hidden variable has no constraints related to charge neutrality or correct charge magnitudes.

9. The computing device as claimed in claim 1, wherein the code that causes the one or more processors to define the second neural network comprises code that cause the one or more processors to define the second neural network have either no message passing layer or one message passing layer.

10. A computer-implemented method of augmenting an existing machine learning interatomic potential systems (MLIP) in an atomistic system, comprising:
defining a long-range neural network to map invariant features of each atom to a hidden variable; and
performing an Ewald summation on the hidden variables from all atoms in the system to determine a long-range energy of the system.

11. The computer-implemented method as claimed in claim 9, wherein the existing MLIP is selected from the group consisting of: Multi-layer Atomic Cluster Expansion (MACE), MACE for Transferable Organic Force Fields (MACE-OFF), NequIP, Cartesian Atomic Cluster Expansion (CACE), and Materials Graph Library (MatGL).

12. The computer-implemented method as claimed in claim 9 further comprising predicting a latent charge for each atom as the hidden variables.

13. The computer-implemented method as claimed in claim 12, wherein predicting the latent charge for each atom occurs in a short-range neural network or is done by the existing MLIP and passed to the long-range neural network.

14. The computer-implemented method as claimed in claim 12, wherein determining the short-range energy of the system comprises:
defining a short-range neural network to determine local atomic energy from descriptors of each atom; and
summing the local atomic energies for all atoms to determine the short-range energy.

15. The computer-implemented method as claimed in claim 12, wherein determining the short-range energy of the system comprises determining the short-range energy of the system using the existing MLIP system.

16. The computer-implemented method as claimed in claim 15, wherein summing the short-range energy of the system comprising summing the short-range energy of the system using the existing MLIP system.

17. The computer-implemented method as claimed in claim 12, further comprising determining a loss function between a known value and predicted value of one or more of energy, forces, and stress.

18. The computer-implemented method as claimed in claim 17, further comprising using the loss function to adjust operation of the long-range neural network.

19. The computer-implemented method as claimed in claim 11, further comprising comprises predicting Born effective charge (BEC) tensors for each atom.

20. The computer-implemented method as claimed in claim 19, further comprising using the BEC tensors to determine electrical response properties of the atoms comprising one or more of capacitance, dielectric constant, ferroelectricity, piezoelectricity, ionic conductivity, and infrared spectra.
